(19) United States
(12) Patent Application Publication
(10) Pub. No.: US 2007/0270564 A1
(43) Pub. Date: Nov. 22, 2007

(54) Method of enhancing the cure time of polyurethane based systems

(76) Inventors: Robert B. Turner, Georgetown, TX (US); Thomas Kurth, Applegate, OR (US)

Correspondence Address: MCKELLAR IP LAW, PLLC, 784 SOUTH POSEYVILLE ROAD, MIDLAND, MI, 48640, US

(21) Appl. No.: 11/800,995

(22) Filed: May 8, 2007

Related U.S. Application Data
(60) Provisional application No. 60/801,571, filed on May 18, 2006.

(51) Int. Cl. C08G 18/00

(52) U.S. Cl. 528/44

(57) ABSTRACT

Polyurethane curable systems that contain an aminated glycerol as a catalyst to enhance the cure rate of the systems. The systems are based on polyoxyalkylene polyols that can be either polyether or polyester polyols. In addition, the polyols can be those that are provided by natural oils, such as soybean, corn oils, and the like. The polyols are typically dihydroxy functional, but can be tri- or quadra-functional or more. The systems are comprised of the reaction of such polyols with organic isocyanates, including the use of chain extenders from diols, or a mixture of triols and diols, such that the overall functionality of the mixture is generally less than 2.3. The organic isocyanates are also at least di-functional and can be tri- or greater functional, with regard to the isocyanate groups used on such molecules. The polyurethane systems can be, for example, elastomers, sealants, adhesives, or foamable systems.

This application claims priority from U.S. Provisional Patent application 60/801,571, filed May 18, 2006.

### FIELD OF THE INVENTION

The present invention deals with polyurethane curable systems that contain an aminated glycerol as a catalyst to enhance the cure rate of the systems. The systems are based on polyoxyalkylene polyols that can be either polyether or polyester polyols. In addition, the polyols can be those that are provided by natural oils, such as soybean, corn oils, and the like. The polyols are typically dihydroxy functional, but can be tri- or quadra-functional or more. The systems are comprised of the reaction of such polyols with organic isocyanates, including the use of chain extenders, from diols, or a mixture of triols and diols, such that the overall functionality of the mixture is generally less than 2.3. The organic isocyanates are also at least di-functional and can be tri- or greater functional, with regard to the isocyanate groups used on such molecules. For purposes of this invention, the polyurethane systems can be, for example, elastomers, sealants, adhesives, or foamable systems.

### BACKGROUND OF THE INVENTION

The invention disclosed and claimed herein deals with a novel method of enhancing the cure time of polyurethane based systems, and compositions for that use. The enhanced method is provided by the use of aminated glycerol as a catalyst in the polyurethane systems.

Because polyurethane chemistry is very old in the art and because of the wide application of polyurethane elastomers, sealants, adhesives, and foams, the systems tend to be inexpensive and such systems can be tailored to fit almost any application with specific physical properties.

It has been discovered by inventor herein that aminated glycerol can be utilized as a catalyst for polyurethane systems to enhance the cure rate of the curing polyurethane systems. It is believed by the inventor herein that aminated glycerol has not been used for this purpose heretofore.

### THE INVENTION

One aspect of the invention herein is the use of aminated glycerol as a catalyst for enhancing the cure time of polyurethane systems wherein the method comprises reacting a polyurethane system in the presence of aminated glycerol, the amount of aminated glycerol being based on the total weight of the polyurethane system and being in the range of 0.1 to 15 weight percent.

A further embodiment of this invention is a composition of matter comprising as incipient components, a polyurethane system and aminated glycerol as a catalyst.

Additional embodiments of this invention are cured polyurethane materials from the inventive method comprising elastomers, sealants, adhesives, and foams, sprayed or molded.

Another embodiment of this invention is the use of by-produced glycerol from the manufacture of biodiesel from natural oils as the base glycerol for preparing aminated glycerol.

Still further, an embodiment of this invention is the preparation of aminated glycerol using ammonia in the presence of alumina as the catalyst.

And yet another embodiment of this invention is a composition of matter that is an aminated glycerol produced by the methods set forth herein.

An especial embodiment of this invention is an aminated glycerol that is produced from glycerol that is by produced from the manufacture of biodiesel fuel.

### DETAILED DESCRIPTION OF THE INVENTION

The essence of this invention is the use of aminated glycerol as a catalyst for enhancing the cure rate of curable polyurethane systems. By “enhanced”, for purposes of this invention, it is meant that the cure rate of curable polyurethane systems is decreased over normal cure rates. For example, a normal cure time for a standard polyurethane system (see, for example, comparative example 1 in this specification) is 36 hours, and the tack free time is also 36 hours. The determination of “tack free” time is based on touching the curing polyurethane system with a wooden tongue depressor and determining that none of the polyurethane system sticks to the tongue depressor. Once it is determined that the composition is tack free, then the system is handled by hand to determine when the system is cured.

The aminated glycerol is obtained from the amination of glycerin. The feedstock of glycerin in the United States is at an all-time high owing to the increased production of biodiesel fuel and as a result of the increased derivation from biobased mass. It is now more economical than synthetic glycerin.

One method of preparing aminated glycerol is by treating the glycerol with ammonia in the vapor phase using alumina as the catalyst. This method results in a mixture of aminated glycerols, in that, one, two or three hydroxyls can be aminated. Separation of the various monoamino, diamino, and triamino compounds can be undertaken to provide individual species, if desired. It is not difficult to aminate one or two hydroxyls, but it is difficult to aminate all three hydroxyls on glycerol. Terminal hydroxyls are the easiest to aminate. This invention also contemplates primary and secondary amines, and mixtures thereof, on glycerol.

The amount of aminated glycerol that is used is dependent on the type of curable polyurethane system that is being catalyzed. The amount ranges from 0.1 weight percent to about 15 weight percent based on the weight of the polyurethane system.

A preferred range for the aminated glycerol is 0.5 to 10 weight percent, and a most preferred range is 1 to 8 weight percent, all based on the total weight of the polyurethane system.

The amount of aminated glycerol affects the timing of the gel point of the cure reaction as well as the total cure time. The cross-link density is increased and the products are tougher. Ordinarily, in this invention, the functionality of the aminated glycerol is higher than the base polyols used in the curable polyurethane system. The percentage of aminated glycerol works best as a catalyst in amounts at one tenth to one percent. The speed of the reaction in many cases is too fast at levels above five percent for molded polyurethane parts. In levels above five percent, the catalyst has applications in sprayed coatings and fast reacting foams. The aminated glycerol appears to be stable for the same term as the base polymers it has been tested in. The aminated glycerol is also stable in the polyurethane prior to reaction, that is, no phase separation was observed.

Polyurethane systems are based on reactions of polyols with organic isocyanates with or without a chain extender. Polyols are well-known in the art and do not need further discussion herein, as are the organic isocyanates. The structures of polyols can vary widely depending upon the desired application.

The production of polyurethane foams is also a well-known art as is the art of spraying or coating such materials.

### EXAMPLES

### Example 1 Comparative Example not within the Scope of the Instant Invention

One hundred grams of a 6000 molecular weight triol obtained from Bayer and known as Bayer 3900 was reacted with a tri-functional isocyanate (Bayer 2903) and the reaction time was 36 hours. The tack free time was also 36 hours.

### Example 2

The same components as were reacted in example 1 were reacted in the presence of 3 grams of aminated glycerol and the reaction time was 3 minutes.

### Example 3

The same components as were reacted in example 2 were reacted in the presence of 5 grams of aminated glycerol and the reaction time was 2.5 minutes.

### Example 4

The same components as were reacted in example 2 were reacted in the presence of 10 grams of aminated glycerol and the reaction time was 0.8 minutes.

### Example 5

The same components as were reacted in example 2 were reacted in the presence of 25 grams of aminated glycerol and the reaction time was 10 seconds.

What is claimed is:

1. A method of enhancing the cure time of curable polyurethane-based systems, the method comprising, reacting a polyurethane system in the presence of aminated glycerol, the amount of aminated glycerol being based on the total weight of the polyurethane system and being in the range of 0.1 to 15 weight percent.

2. The method as claimed in claim 1 wherein glycerol has at least one of its hydroxyl groups replaced by an amine group.

3. The method as claimed in claim 2 wherein the amine group is a primary amine.

4. A composition of matter comprising as incipient components, a polyurethane system and aminated glycerol.

5. A composition of matter as claimed in claim 4 wherein the polyurethane system is an elastomer system.

6. A composition of matter as claimed in claim 4 wherein the polyurethane system is a foamable system.

7. A composition of matter as claimed in claim 6 wherein the foamable system is a sprayable foamable system.

8. A composition of matter as claimed in claim 5 wherein the elastomer system is a molded system.

9. A composition of matter as claimed in claim 5 wherein the elastomer system is an extruded system.

10. A composition of matter as claimed in claim 5 wherein the elastomer system is a reaction injected molded system.

11. A composition of matter as claimed in claim 4 that is a polyurethane sealant.

12. A method of preparing aminated glycerol, the method comprising treating glycerol with ammonia in the vapor phase using alumina as the catalyst.

13. The method as claimed in claim 12 wherein the glycerol is derived as a by-product of the manufacture of biodiesel from natural oils.

14. The method as claimed in claim 13 wherein the natural oil is soybean oil.

15. Aminated glycerol prepared by the method as claimed in claim 12.

16. Aminated glycerol prepared by the method as claimed in claim 13.

17. Aminated glycerol prepared by the method as claimed in claim 14.
